(19) United States
(12) Patent Application Publication
(10) Pub. No.: US 2026/0132897 A1
(43) Pub. Date: May 14, 2026

(54) LED ASSEMBLY, LED FILAMENT AND LED LAMP

(71) Applicant: SAVANT TECHNOLOGIES LLC, East Cleveland, OH (US)

(72) Inventors: Kun XIAO, Shanghai (CN); Jie GAO, Shanghai (CN); Xuda LI, Shanghai (CN)

(73) Assignee: SAVANT TECHNOLOGIES LLC, East Cleveland, OH (US)

(21) Appl. No.: 19/380,017

(22) Filed: Nov. 5, 2025

(30) Foreign Application Priority Data
Nov. 11, 2024 (CN) 2024116039289

(51) Int. Cl. F21K 9/64; F21K 9/232

(52) U.S. Cl. CPC F21K 9/64; F21K 9/232

(57) ABSTRACT

Provided is an LED assembly, an LED filament and an LED lamp, where the LED assembly has at least one first blue LED chip having a peak emission wavelength between 445 nm and 465 nm, at least one second blue LED chip having a peak emission wavelength between 465 and 480 nm, and the first blue LED chip and the second blue LED chip are combined to form an LED package, and a yellow-green phosphor having a peak emission wavelength between 510 nm and 535 nm, coated on the surface of the LED package. The peak emission wavelength of blue light of an LED assembly is dispersed within the ranges of 445 nm to 465 nm and 465 nm to 480 nm, and the peak intensity of the blue light is reduced within the two ranges.

### CROSS-REFERENCE TO RELATED APPLICATIONS

This application claims priority to Chinese Patent Application Serial Number 2024116039289, filed Nov. 11, 2024, which is herein incorporated by reference.

### TECHNICAL FIELD

The present disclosure relates to the field of lamps, and more particularly, to an LED assembly, an LED filament and an LED lamp capable of reducing the blue-light hazard.

### BACKGROUND

With the development of LED technology, white LED lamps are increasingly popular due to their energy conservation and long service life. However, a white LED lamp, especially in the case of a high correlated color temperature (CCT), such as 5000K or more, emits a high proportion of blue light, and long-term exposure to high-density blue light is adverse to the health of human eyes. The hazard of the blue light (400 nm to 500 nm) to human eyes mainly comes from the part with a shorter wavelength, especially the blue light with a peak emission wavelength between 415 nm and 455 nm, which can penetrate the lens directly to reach the retina and cause hazard to photoreceptor cells and pigment epithelium of the retina, which may result in ocular diseases such as reduced vision, visual fatigue and even macular degeneration. In addition, blue light, which is an indispensable component in the formation process of white light, especially the lack of blue light having a peak emission wavelength between 415 nm and 455 nm may cause significant deterioration in luminous efficacy and color rendering of white light.

In order to reduce the potential hazard to human eyes caused by blue light, in the prior art, the peak of the emission wavelength of the blue LED chip in the white LED lamp is shifted out of the range of 415 nm to 455 nm, for example, shifted to around 475 nm. However, although the hazard to human eyes caused by the blue light in the white LED lamp is reduced to some extent, the luminous efficacy and color rendering of the white LED lamp are also reduced. Furthermore, using a single blue LED chip with a wavelength of 465 to 480 nm can also lead to an excessively high intensity of blue light.

### SUMMARY OF THE INVENTION

In order to overcome the described technical problem, the present disclosure provides an LED assembly, an LED filament and an LED lamp. By combining a blue LED chip having a peak emission wavelength between 445 nm and 465 nm with a blue LED chip having a peak emission wavelength between 465 nm and 480 nm, the peak emission wavelength of blue light from an LED assembly or LED filament is dispersed over the ranges of 445 nm to 465 nm and 465 nm to 480 nm, the peak intensity of the blue light is reduced within two ranges, and a predetermined phosphor is coated on the surface of the LED package, which reduces the hazard to human eyes caused by blue light, and also avoids the deterioration of the luminous efficacy and color rendering of white light.

According to an embodiment of the present disclosure, provided is an LED assembly, comprising: at least one first blue LED chip having a peak emission wavelength between 445 nm and 465 nm; at least one second blue LED chip having a peak emission wavelength between 465 and 480 nm, wherein the first blue LED chip and the second blue LED chip are combined to form an LED package; and a yellow-green phosphor, coated on the surface of the LED package, and having a peak emission wavelength between 510 nm and 535 nm.

In the foregoing manner, the peak emission wavelength of blue light of the LED assembly is dispersed within the ranges of 445 nm to 465 nm and 465 nm to 480 nm, the peak intensity of the blue light is reduced within the two ranges, and a yellow-green phosphor is coated on the surface of an LED package, which reduces the hazard to human eyes caused by blue light, and also avoids the deterioration of the luminous efficacy and color rendering of white light.

In the LED assembly according to the present disclosure, the yellow-green phosphor comprises aluminate series yellow powder and yellow-green powder, and silicate series yellow powder and yellow-green powder.

In the foregoing manner, a specific example of the yellow-green phosphors is provided.

In the LED assembly according to the present disclosure, the yellow-green phosphor is dispersed in the fluorescent adhesive, and the mass percentage of the yellow-green phosphor in the fluorescent adhesive is 4% to 15%.

In the foregoing manner, a specific example of the content of the yellow-green phosphor in the fluorescent adhesive is provided.

In the LED assembly according to the present disclosure, the LED assembly further comprises a manganese fluoride red phosphor, coated on the surface of the LED package.

By coating the manganese fluoride red phosphor on the surface of the LED package, the luminous efficacy and color rendering of white light can be further improved.

In the LED assembly according to the present disclosure, the manganese fluoride red phosphor is potassium fluorosilicate doped with manganese.

In the foregoing manner, a specific example of the manganese fluoride red phosphor is provided.

In LED assembly according to the present disclosure, the manganese fluoride red phosphor has a peak emission wavelength between 600 nm and 650 nm, and a full-width at half maximum of less than 60 nm.

The manganese fluoride red phosphor with the peak emission wavelength between 600 nm and 650 nm can further improve the luminous efficacy and color rendering of white light.

In the LED assembly according to the present disclosure, the manganese fluoride red phosphor is dispersed in the fluorescent adhesive, and the mass percentage of the manganese fluoride red phosphor in the fluorescent adhesive is 5% to 10%.

In the foregoing manner, a specific example of the content of the manganese fluoride red phosphor in the fluorescent adhesive is provided.

In the LED assembly according to the present disclosure, the LED assembly has at least two layers of fluorescent adhesive, and the manganese fluoride red phosphor and the yellow-green phosphor are respectively located in one of the at least two layers of fluorescent adhesive.

In the foregoing manner, the distribution forms of the manganese fluoride red phosphor and the yellow-green phosphor in the fluorescent adhesive are provided.

In the LED assembly according to the present disclosure, a first layer of the at least two layers of fluorescent adhesive covers the LED package, and a second layer of the at least two layers of fluorescent adhesive covers the first layer of fluorescent adhesive.

In the foregoing manner, a specific configuration form of the layer of fluorescent adhesive is provided.

In the LED assembly according to the present disclosure, the manganese fluoride red phosphor is dispersed in the first layer of fluorescent adhesive, the yellow-green phosphor is dispersed in the second layer of fluorescent adhesive, and the mass percentage of the manganese fluoride red phosphor in the first layer of fluorescent adhesive is 5% to 10%.

In the foregoing manner, a specific example of the content of the manganese fluoride red phosphor in the fluorescent adhesive is provided.

According to another embodiment of the present disclosure, provided is an LED filament, comprising: a substrate; at least one first blue LED chip mounted on the substrate, the at least one first blue LED chip having a peak emission wavelength between 445 nm and 465 nm; at least one second blue LED chip mounted on the substrate, the at least one second blue LED chip having a peak emission wavelength between 465 nm and 480 nm, wherein the at least one first blue LED chip and the at least one second blue LED chip are combined with the substrate to form an LED package; and a yellow-green phosphor, dispersed in the fluorescent adhesive and having a peak emission wavelength between 510 nm and 535 nm, wherein the fluorescent adhesive is coated on the surface of the LED package.

In the foregoing manner, the peak emission wavelength of blue light of the LED assembly is dispersed within the ranges of 445 nm to 465 nm and 465 nm to 480 nm, the peak intensity of the blue light is reduced within the two ranges, and the yellow-green phosphor is coated on the surface of an LED package, which reduces the hazard to human eyes caused by blue light, and also avoids the deterioration of the luminous efficacy and color rendering of white light.

In the LED filament according to the present disclosure, the yellow-green phosphor comprises aluminate series yellow powder and yellow-green powder, and silicate series yellow powder and yellow-green powder.

In the foregoing manner, a specific example of the yellow-green phosphors is provided.

In the LED filament according to the present disclosure, the mass percentage of the yellow-green phosphor in the fluorescent adhesive is 4% to 15%.

In the foregoing manner, a specific example of the content of the yellow-green phosphor in the fluorescent adhesive is provided.

In the LED filament according to the present disclosure, the LED filament further comprises a manganese fluoride red phosphor.

By coating the manganese fluoride red phosphor on the surface of the LED package, the luminous efficacy and color rendering of white light can be further improved.

In the LED filament according to the present disclosure, the manganese fluoride red phosphor has a peak emission wavelength between 600 nm and 650 nm, and a full-width at half maximum of less than 60 nm.

The manganese fluoride red phosphor with the peak emission wavelength between 600 nm and 650 nm can further improve the luminous efficacy and color rendering of white light.

In the LED lamp filament according to the present disclosure, the LED lamp filament has at least two layers of fluorescent adhesive, wherein a first layer of fluorescent adhesive covers the LED package, a second layer of fluorescent adhesive covers the first layer of fluorescent adhesive, and the manganese fluoride red phosphor and the yellow-green phosphor are respectively located in one of the at least two layers of fluorescent adhesive.

In the foregoing manner, the distribution forms of the manganese fluoride red phosphor and the yellow-green phosphor in the fluorescent adhesive are provided.

According to another embodiment of the present disclosure, provided is an LED lamp, applicable to be connected to a power supply to provide an illumination light source, comprising: the LED assembly according to the present disclosure; and a lamp body configured to accommodate the LED assembly.

In the foregoing manner, the peak emission wavelength of blue light of the LED lamp is dispersed within the ranges of 445 nm to 465 nm and 465 nm to 480 nm, and the peak intensity of the blue light is reduced within the two ranges, which reduces the hazard to human eyes caused by blue light, and furthermore, the yellow-green phosphor and/or the manganese fluoride red phosphor is coated on the surface of an LED package, which avoids the deterioration of the luminous efficacy and color rendering of white light.

According to another embodiment of the present disclosure, provided is an LED lamp, applicable to be connected to a power supply to provide an illumination light source, comprising: the LED filament according to the present disclosure; and a lamp body configured to accommodate the LED filament.

In the foregoing manner, the peak emission wavelength of blue light of an LED lamp is dispersed within the ranges of 445 nm to 465 nm and 465 nm to 480 nm, and the peak intensity of the blue light is reduced within the two ranges, which reduces the hazard to human eyes caused by blue light, and furthermore, the yellow-green phosphor and/or the manganese fluoride red phosphor is coated on the surface of an LED package, which avoids the deterioration of the luminous efficacy and color rendering of white light.

### BRIEF DESCRIPTION OF THE DRAWINGS

The drawings illustrated herein are used for providing further understanding of the present disclosure and constitute a part of the present disclosure, and the exemplary embodiments of the present disclosure and illustrations thereof are used for explaining the present disclosure, rather than constitute inappropriate limitation on the present disclosure. In the drawings:

FIGS. 1A and 1B show schematic diagrams of an LED assembly according to an embodiment of the present disclosure.

FIG. 2 shows a spectral power distribution diagram of an LED assembly according to an embodiment of the present disclosure and a spectral power distribution diagram of a conventional LED assembly.

FIGS. 3A and 3B show schematic diagrams of an LED filament according to another embodiment of the present disclosure.

FIG. 4 is an example of an LED lamp according to another embodiment of the present disclosure.

### DETAILED DESCRIPTION

In order to enable those skilled in the art to understand the solutions of some embodiments of the present disclosure better, hereinafter, the technical solutions in the embodiments of the present disclosure will be described clearly and thoroughly with reference to the accompanying drawings of embodiments of the present disclosure. Obviously, the embodiments as described are only some of the embodiments of the present disclosure, and are not all the embodiments. On the basis of the embodiments in the present disclosure, all other embodiments obtained by a person of ordinary skill in the art without inventive effort shall all belong to the scope of protection of the present disclosure.

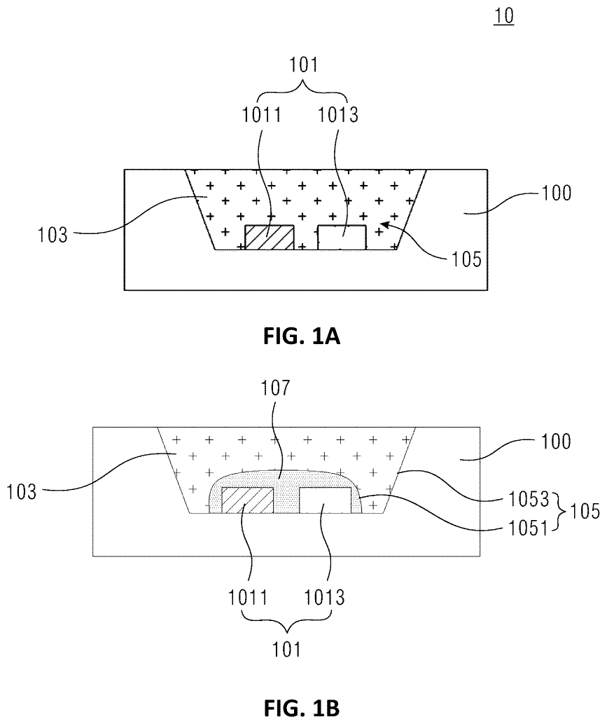

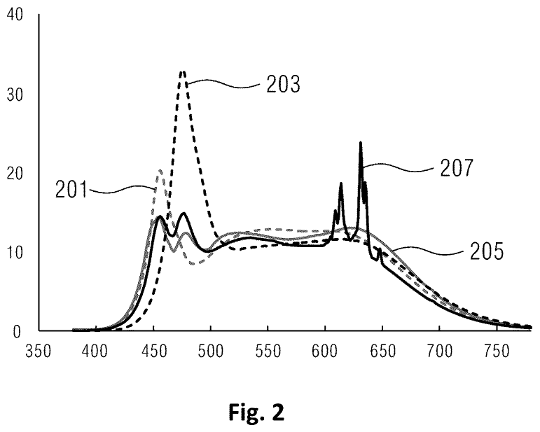

According to an embodiment of the present disclosure, provided is an LED assembly. FIGS. 1A and 1B show schematic diagrams of an LED assembly according to an embodiment of the present disclosure, wherein FIG. 1A shows a configuration of the LED assembly, the LED assembly can be used as a light emitting unit in various LED lamps or lighting fixtures, for example, mounted on a PCB of a related lamp and connected to an external power supply to emit light. Another configuration of the LED assembly is shown in FIG. 1B. FIG. 2 shows a spectral power distribution diagram of an LED assembly according to an embodiment of the present disclosure and a spectral power distribution diagram of a conventional LED assembly. The following describes an LED assembly according to an embodiment of the present disclosure with reference to FIG. 1A to FIG. 2.

As shown in FIGS. 1A and 1B, an LED assembly 10 implemented in accordance with the present disclosure may comprise at least one first blue LED chip 1011 and at least one second blue LED chip 1013.

In the present disclosure, the number of the first blue LED chips 1011 and the number of the second blue LED chips 1013 are both one or more. For ease of understanding, FIG. 1 only shows the cases where one first blue LED chip 1011 and one second blue LED chip 1013 are arranged in parallel, but the present disclosure is not limited thereto. The number of the first blue LED chips 1011 and the number of the second blue LED chips 1013 may be set as required.

Each of the first blue LED chips 1011 is a blue LED chip having a peak emission wavelength between 445 nm and 465 nm, and such chips can be obtained commercially.

Each of the second blue LED chips 1013 is a blue LED chip having a peak emission wavelength between 465 nm and 480 nm, and such chips can also be obtained commercially.

The first blue LED chips 1011 and the second blue LED chips 1013 are arranged in parallel to form the LED package 101.

The LED assembly 10 according to the embodiments of the present disclosure may also include a support 100 configured to support the LED package 101 in a groove.

As shown in FIGS. 1A and 1B, the LED package 10 may also include a yellow-green phosphor 103 coated on the surface of the LED package 101.

The yellow-green phosphor 103 is uniformly dispersed in the fluorescent adhesive 105. The fluorescent adhesive 105 may be a silicone adhesive, an epoxy adhesive, or other matrix material. It should be noted here that, in addition to the yellow-green phosphor 103, the phosphor dispersed in the fluorescent adhesive 105 further includes other conventional phosphors, such as a conventional red phosphor (an example of the conventional red phosphor may include, for example, a nitride phosphor), but the present disclosure is not limited thereto. Since the invention of the present disclosure is not directed to other conventional phosphors dispersed in the fluorescent adhesive, in order to avoid obscuring the present invention caused by excessive description, the description of other phosphors not related to the present disclosure, including the conventional red phosphor, will not be specifically described in the following embodiments.

The yellow-green phosphor 103, for example, may include aluminate series yellow powder and yellow-green powder (for example, YAG, GaYAG, and LuAG) and silicate series yellow powder and yellow-green powder (for example, silicate), and the mass percentage thereof in the fluorescent adhesive is between 4% to 15%. However, the present disclosure is not limited thereto, and the content of the yellow-green phosphor 103 in the fluorescent adhesive can be set according to the expected color temperature of the LED assembly.

In the present disclosure, the yellow-green phosphor 103 has a peak emission wavelength between 510 nm and 535 nm.

Optionally, besides the yellow-green phosphor 103, the manganese fluoride red phosphor (for example, potassium fluorosilicate doped with manganese) may be uniformly dispersed in the fluorescent adhesive 105, and the fluorescent adhesive in which the yellow-green phosphor 103 and manganese fluoride red phosphor are dispersed is coated on the surface of the LED package 101.

The mass percentage of the manganese fluoride red phosphor in the fluorescent adhesive 105 is, for example, between 5% to 10%. However, the present disclosure is not limited thereto, and the content of the manganese fluoride red phosphor in the fluorescent adhesive may be set according to the expected color temperature of the LED assembly.

In the present disclosure, the manganese fluoride red phosphor has a peak emission wavelength between 600 nm and 650 nm, and a full-width at half maximum of less than 60 nm.

In FIG. 1A, the yellow-green phosphor 103/the yellow-green phosphor 103 and the manganese fluoride red phosphor (not shown in FIG. 1A) are dispersed in a single layer of fluorescent adhesive 105. However, the present disclosure is not limited thereto. The fluorescent adhesive 105 may comprise at least two layers. For simplicity, in FIG. 1B, the fluorescent adhesive 105 comprises a first layer of fluorescent adhesive 1051 and a second layer of fluorescent adhesive 1053, wherein the manganese fluoride red phosphor and the yellow-green phosphor are respectively located in one of the two layers of fluorescent adhesive.

Specifically, as shown in FIG. 1B, the first layer of fluorescent adhesive 1051 covers the LED package 101, and the second layer of fluorescent adhesive 1053 covers the first layer of fluorescent adhesive 1051. The manganese fluoride red phosphor 107 is dispersed in the first layer of fluorescent adhesive 1051, the yellow-green phosphor 103 is dispersed in the second layer of fluorescent adhesive 1053, and the mass percentage of the manganese fluoride red phosphors in the first layer of fluorescent adhesive 1051 is about 5% to 10%.

Although FIG. 1B shows that the manganese fluoride red phosphor 107 is dispersed in the first layer of fluorescent adhesive 1051, and the yellow-green phosphor 103 is dispersed in the second layer of fluorescent adhesive 1053, the present disclosure is not limited thereto. The yellow-green phosphor 103 may be dispersed in the first layer of fluorescent adhesive 1051, and the manganese fluoride red phosphor 107 may be dispersed in the second layer of fluorescent adhesive 1053.

In order to further understand the present disclosure, the effects brought about by the LED assembly according to the present disclosure will be described in details below in conjunction with FIG. 2 and relevant experimental test data.

In FIG. 2, the horizontal axis represents wavelength, and the vertical axis represents spectral intensity. A curve 201 shows a spectral power distribution diagram of a conventional LED assembly having a single blue LED chip with a peak emission wavelength of around 455 nm; a curve 203 shows a spectral power distribution diagram of a conventional LED assembly having a single blue LED chip with a shifted peak emission wavelength of around 475 nm; a curve 205 shows a spectral power distribution diagram of an LED assembly 10 in cases where the LED assembly 10 according to the present disclosure comprises twelve first blue LED chips 1011 and twelve second blue LED chips 1013 and the described yellow-green phosphor is coated on the surface of the LED package 101; a curve 207 shows a spectral power distribution diagram of an LED assembly 10 in cases where the LED package 101 according to the present disclosure comprises twelve first blue LED chips 1011 and twelve second blue LED chips 1013 and the described yellow-green phosphor and manganese fluoride red phosphor are coated on the surface of the LED package 101.

The following table 1 shows the measured parameter values of the LED assemblies corresponding to the curves 201 to 207. For the particular description of the relevant parameters in table 1, reference may be made to the low blue light detection standard for displays by Rhein Chemie TüV, which was released in June 2016 as 2 pfg 2383 standard. This standard aims to assess the blue light radiation levels of display screens and their impact on the eyes.

TABLE 1

| | Correlated | | | | Blue- | Hazardous |
|---|---|---|---|---|---|---|
| | Color | Color | | Blue light | green light | blue-light |
| | Temperature | rendering | Blue-light | ratio LBP | ratio LBPR | ratio LBEP |
| Recipe | CCT | index Ra | hazard LB | <20% | <2 | <50% |
| Conventional 455 nm | 5005 | 93 | 100.00% | 17% | 1.65 | 38% |
| blue light | | | | | | |
| Single 475 nm blue | 4981 | 73 | 95.50% | 28% | 2.68 | 7% |
| light | | | | | | |
| Dual blue light | 4989 | 92 | 94.50% | 16% | 1.28 | 27% |
| 455 + 475 nm | | | | | | |
| Dual blue light | 4984 | 90 | 99.30% | 17% | 0.69 | 27% |
| 455 + 475 nm | | | | | | |
| manganese fluoride | | | | | | |
| red phosphor | | | | | | |

It can be seen from FIG. 2 and Table 1 that the peak of the curve 203 appears near the wavelength of 475 nm, and the blue-light hazard to human eyes is relatively reduced (the blue-light hazard LB is 95.50%), and the hazardous blue light ratio decreases (the hazardous blue light ratio LBEP being 7%), but compared with the curve 201, in order to maintain the color temperature at a predetermined value (for example, about 5000 K), the peak intensity of the curve 203 is obviously higher than the peak intensity of the curve 201, which results in the obvious deterioration of the luminous efficacy and color rendering of the LED assembly corresponding to the curve 203 (for example, the color rendering index Ra is 73), and furthermore, the other parameters, such as the blue light ratio (the LBP being 28%) and the blue-green-light ratio (the LBPR being 2.68), are also obviously deteriorated.

For cases where the LED assembly 10 according to the present disclosure comprises twelve first blue LED chips 1011 and twelve second blue LED chips 1013 and the described yellow-green phosphor (510 nm to 535 nm) is coated on the surface of the LED package 101, it can be seen from the curve 205 of FIG. 2 and table 1 that the peak value of the curve 205 appears in both ranges of 450 nm to 465 nm and 465 nm to 480 nm, furthermore, the peak intensity is obviously reduced compared with the peak intensity of the curve 201, which significantly reduces the blue-light hazard (LB being 94.50%) to the human eyes, other blue light parameters, such as the ratio of blue light (LBP being 16%), the blue-green light ratio (LBPR being 1.28) and the hazardous blue light ratio (LBEP being 27%) are all optimized relative to the parameter value of a single 455 nm blue light chip, thereby avoiding deterioration of the luminous efficacy and color rendering of the LED assembly at the predetermined color temperature.

For cases where the LED package 101 according to the present disclosure comprises twelve first blue LED chips 1011 and twelve second blue LED chips 1013 and the described yellow-green phosphor and manganese fluoride red phosphor are coated on the surface of the LED package 101, it can be seen from the curve 207 and table 1 of FIG. 2 that the peak value of the curve 207 appears in both ranges of 450 nm to 465 nm and 465 nm to 480 nm, and the peak intensity is significantly lower than that of the curve 201. Compared with the parameter value of a single 455 nm blue light chip, the blue-green light ratio (LBPR being 0.69), the hazardous blue light ratio (LBEP being 27%) and other parameters are significantly reduced. In addition, due to the existence of the manganese fluoride red phosphor, two other peaks appear within the range of 600 nm to 650 nm of the curve 207, and the appearance of these peaks further improves the luminous efficacy and color rendering of the LED assembly.

According to embodiments of the present disclosure, by combining a blue LED chip having a peak emission wavelength between 445 nm and 465 nm with a blue LED chip having a peak emission wavelength between 465 nm and 480 nm, the peak emission wavelength of blue light from LED assembly is dispersed over the ranges of 445 nm to 465 nm and 465 nm to 480 nm, the peak intensity of the blue light is reduced within two ranges, which reduces the hazard to human eyes caused by blue light, and also avoids the deterioration of the luminous efficacy and color rendering of white light. In addition, by coating the yellow-green phosphor/the yellow-green phosphor and the manganese fluoride red phosphor on the surface of the blue LED chip combination, the luminous efficacy and color rendering of white light emitted from the LED assembly are further improved.

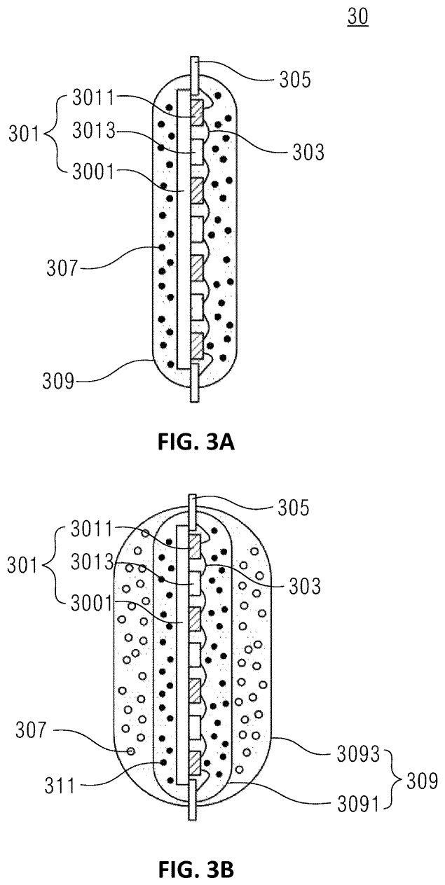

According to another embodiment of the present disclosure, an LED filament is provided. FIGS. 3A and 3B shows a schematic diagram of an LED filament according to another embodiment of the present disclosure.

As shown in FIGS. 3A and 3B, an LED filament 30 according to another embodiment of the present disclosure may include a substrate 3001, at least one first blue LED chip 3011 and at least one second blue LED chip 3013.

In the present disclosure, the number of the first blue LED chips 3011 and the number of the second blue LED chips 3013 are both one or more. FIGS. 3A and 3B only shows the cases where four first blue LED chips 3011 and four second blue LED chips 3013 are arranged in parallel, but the present disclosure is not limited thereto. The number of the first blue LED chips 3011 and the number of the second blue LED chips 3013 may be set as required.

The at least one first blue LED chip 3011 is provided on the substrate 3001, each of the first blue LED chips 3011 is a blue LED chip having a peak emission wavelength between 445 nm and 465 nm, and such chips can be obtained commercially.

The at least one second blue LED chip 3013 and the at least one first blue LED chip 3011 are alternately arranged on the substrate 3001, each of the second blue LED chips 3013 is a blue LED chip having a peak emission wavelength between 465 nm and 480 nm, and such chips can also be obtained commercially.

The first blue LED chip 3011 and the second blue LED chip 3013 which are adjacent to each other are connected by an alloy wire 303, so that, for example, four first blue LED chips 3011 and four second blue LED chips 3013 are connected together in series. The first blue LED chips 3011 and the second blue LED chips 3013, which are connected in series, are combined with the substrate 3001 to form an LED package 301.

The LED filament 30 according to another embodiment of the present disclosure can further include two electrodes 305, which are separately arranged at two ends of the LED package 301 and can electrically connect the LED package 301 to a circuit board (not shown in the figure).

As shown in FIGS. 3A and 3B, the LED filament 30 can further include a yellow-green phosphor 307 coated on the surface of the LED package 301.

The yellow-green phosphor 307 is uniformly dispersed in the fluorescent adhesive 309, and the fluorescent adhesive 309 is coated on the surface of the LED package 301. The fluorescent adhesive 309 may be a silicone adhesive, an epoxy adhesive, or other matrix material.

The yellow-green phosphor 307, for example, may include aluminate series yellow powder and yellow-green powder (for example, YAG, GaYAG, and LuAG) and silicate series yellow powder and yellow-green powder (for example, silicate), and the mass percentage thereof in the fluorescent adhesive 309 is between 4% to 15%. However, the present disclosure is not limited thereto, and the content of yellow-green phosphor 103 in the fluorescent adhesive 309 can be set according to the expected color temperature of the LED filament.

In the present disclosure, the yellow-green phosphor 307 has a peak emission wavelength between 510 nm and 535 nm.

Optionally, besides the yellow-green phosphor 307, the manganese fluoride red phosphor 311 (for example, potassium fluorosilicate doped with manganese) may be uniformly dispersed in the fluorescent adhesive 309, and the fluorescent adhesive in which the yellow-green phosphor 307 and manganese fluoride red phosphor 311 are dispersed is coated on the surface of the LED package 301.

The mass percentage of the manganese fluoride red phosphor 311 in the fluorescent adhesive 309 is, for example, between 5% to 10%. However, the present disclosure is not limited thereto, and the content of the manganese fluoride red phosphor 311 in the fluorescent adhesive 309 can be set according to the expected color temperature of the LED filament.

In the present disclosure, the manganese fluoride red phosphor 311 has a peak emission wavelength between 600 nm and 650 nm, and a full-width at half maximum of less than 60 nm.

In FIG. 3A, the yellow-green phosphor 307/the yellow-green phosphor 307 and the manganese fluoride red phosphor 311 (not shown in FIG. 3A) are dispersed in a single layer of fluorescent adhesive 309. However, the present disclosure is not limited thereto. The fluorescent adhesive 309 may comprise at least two layers. For simplicity, in FIG. 3B, the fluorescent adhesive 309 comprises a first layer of fluorescent adhesive 3091 and a second layer of fluorescent adhesive 3093, wherein the manganese fluoride red phosphor and the yellow-green phosphor are respectively located in one of the two layers of fluorescent adhesive.

Specifically, as shown in FIG. 3B, the first layer of fluorescent adhesive 3091 covers the LED package 301, and the second layer of fluorescent adhesive 3093 covers the first layer of fluorescent adhesive 3091. The manganese fluoride red phosphor 311 is dispersed in the first layer of fluorescent adhesive 3091, the yellow-green phosphor 307 is dispersed in the second layer of fluorescent adhesive 3093, and the mass percentage of the manganese fluoride red phosphor 311 in the first layer of fluorescent adhesive 3091 is about 5% to 10%.

Although FIG. 3B shows that the manganese fluoride red phosphor 311 is dispersed in the first layer of fluorescent adhesive 3091, and the yellow-green phosphor 307 is dispersed in the second layer of fluorescent adhesive 3093, the present disclosure is not limited thereto. The yellow-green phosphor 307 may be dispersed in the first layer of fluorescent adhesive 3091, and the manganese fluoride red phosphor 311 may be dispersed in the second layer of fluorescent adhesive 3093.

According to embodiments of the present disclosure, by combining a blue LED chip having a peak emission wavelength between 445 nm and 465 nm with a blue LED chip having a peak emission wavelength between 465 nm and 480 nm, the peak emission wavelength of blue light from LED filament is dispersed over the ranges of 445 nm to 465 nm and 465 nm to 480 nm, the peak intensity of the blue light is reduced within two ranges, which reduces the hazard to human eyes caused by blue light, and also avoids the deterioration of the luminous efficacy and color rendering of white light. In addition, by coating the yellow-green phosphor/the yellow-green phosphor and the manganese fluoride red phosphor on the surface of the blue LED chip combination, the luminous efficacy and color rendering of white light emitted from the LED filament are further improved.

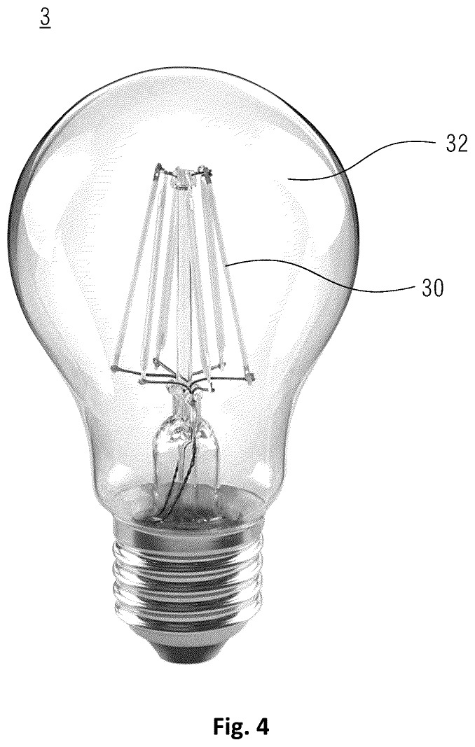

According to another embodiment of the present disclosure, an LED lamp is provided. FIG. 4 is an example of an LED lamp according to another embodiment of the present disclosure. The LED lamp 3 comprises an LED filament 30 and a lamp body 32 for accommodating the LED filament.

As shown in FIG. 4, the LED lamp 3 is a filament LED lamp, and the LED filament 30 according to another embodiment of the present disclosure is used as a filament in the LED lamp 3.

The LED lamp 3 shown in FIG. 4 is merely a specific example of a lamp including an LED filament 30 according to another embodiment of the present disclosure, and the present disclosure is not limited thereto. The LED lamp 3 may have different patterns. The LED lamp 3 can also be a lamp that includes the LED assembly 10 according to the embodiments of the present disclosure.

The LED lamp 3 according to another embodiment of the present disclosure can also reduce the hazard to human eyes caused by blue light, and also avoid the deterioration of the luminous efficacy and color rendering of white light emitted from the LED lamp 3.

The description above only relate to preferred embodiments of the present disclosure. It should be noted that for a person with ordinary skill in the art, several improvements and modifications can also be made without departing from the technical principle of the present disclosure, and these improvements and modifications shall also be considered as within the scope of protection of the present disclosure.

1. An LED assembly, comprising:
at least one first blue LED chip having a peak emission wavelength between 445 nm and 465 nm;
at least one second blue LED chip having a peak emission wavelength between 465 nm and 480 nm, wherein the at least one first blue LED chip and the at least one second blue LED chip are combined to form an LED package; and
yellow-green phosphor coated on the surface of the LED package, the yellow-green phosphor having a peak emission wavelength between 510 nm and 535 nm.

2. The LED assembly according to claim 1, wherein
the yellow-green phosphor comprises aluminate series yellow powder and yellow-green powder, and silicate series yellow powder and yellow-green powder.

3. The LED assembly according to claim 2, wherein
the yellow-green phosphor is dispersed in a fluorescent adhesive, and the mass percentage of the yellow-green phosphor in the fluorescent adhesive is 4% to 15%.

4. The LED assembly according to claim 1, wherein the LED assembly further comprises:
a manganese fluoride red phosphor coated on the surface of the LED package.

5. The LED assembly according to claim 4, wherein
the manganese fluoride red phosphor is potassium fluorosilicate doped with manganese.

6. The LED assembly according to claim 5, wherein
the manganese fluoride red phosphor has a peak emission wavelength between 600 nm and 650 nm, and a full-width at half maximum of less than 60 nm.

7. The LED assembly according to claim 4, wherein
the manganese fluoride red phosphor is dispersed in the fluorescent adhesive, and the mass percentage of the manganese fluoride red phosphor in the fluorescent adhesive is 5% to 10%.

8. The LED assembly according to claim 7, wherein
the LED assembly has at least two layers of fluorescent adhesive, and the manganese fluoride red phosphor and the yellow-green phosphor are respectively located in one of the at least two layers of fluorescent adhesive.

9. The LED assembly according to claim 8, wherein
a first layer of the at least two layers of fluorescent adhesive covers the LED package, and a second layer of the at least two layers of fluorescent adhesive covers the first layer of fluorescent adhesive.

10. The LED assembly according to claim 9, wherein
the manganese fluoride red phosphor is dispersed in the first layer of fluorescent adhesive, the yellow-green phosphor is dispersed in the second layer of fluorescent adhesive, and the mass percentage of the manganese fluoride red phosphor in the first layer of fluorescent adhesive is 5% to 10%.

11. An LED filament comprising:
a substrate;
at least one first blue LED chip mounted on the substrate, the at least one first blue LED chip having a peak emission wavelength between 445 nm and 465 nm;
at least one second blue LED chip mounted on the substrate, the at least one second blue LED chip having a peak emission wavelength between 465 nm and 480 nm, wherein the at least one first blue LED chip and the at least one second blue LED chip are combined with the substrate to form an LED package; and
yellow-green phosphor dispersed in the fluorescent adhesive and having a peak emission wavelength between 510 nm and 535 nm, wherein the fluorescent adhesive is coated on the surface of the LED package.

12. The LED filament according to claim 11, wherein
the yellow-green phosphor comprises aluminate series yellow powder and yellow-green powder, and silicate series yellow powder and yellow-green powder.

13. The LED filament according to claim 12, wherein
the mass percentage of the yellow-green phosphor in the fluorescent adhesive is 4% to 15%.

14. The LED filament according to claim 13, wherein
the LED filament further comprises a manganese fluoride red phosphor.

15. The LED filament according to claim 14, wherein
the manganese fluoride red phosphor has a peak emission wavelength between 600 nm and 650 nm, and a full-width at half maximum of less than 60 nm.

16. The LED filament according to claim 14, wherein
the LED filament has at least two layers of fluorescent adhesive, wherein a first layer of fluorescent adhesive covers the LED package, a second layer of fluorescent adhesive covers the first layer of fluorescent adhesive, and the manganese fluoride red phosphor and the yellow-green phosphor are respectively located in one of the at least two layers of fluorescent adhesive.

17. An LED lamp, applicable to be connected to a power supply to provide an illumination light source, comprising:
the LED assembly according to claim 1; and
a lamp body configured to accommodate the LED assembly.

18. An LED lamp, applicable to be connected to a power supply to provide an illumination light source, comprising:
the LED filament according to claim 11; and
a lamp body configured to accommodate the LED filament.
